(19) United States
(12) Patent Application Publication
(10) Pub. No.: US 2026/0016791 A1
(43) Pub. Date: Jan. 15, 2026

(54) Electromechanical Display Systems and Methods

(71) Applicant: Carlos Andres Barcelo, Los Alamitos, CA (US)

(72) Inventor: Carlos Andres Barcelo, Los Alamitos, CA (US)

(21) Appl. No.: 19/262,211

(22) Filed: Jul. 8, 2025

Related U.S. Application Data
(60) Provisional application No. 63/669,205, filed on Jul. 9, 2024.

(51) Int. Cl. G04C 19/04

(52) U.S. Cl. CPC G04C 19/04

(57) ABSTRACT

Systems and methods are disclosed that enable populating and updating a display comprising display elements that comprise movable physical objects. These may include, for example, devices and algorithms for setting and updating a clock display that comprises display elements comprising plastic disks that roll through a system of ramps, tracks, and/or enclosed areas as they move through the system under the effects of gravity and other forces provided by energy sources. A computerized controller uses a color sensor at the front of a queue of display elements to identify the next display element to be placed within the system, so as to route it to a specified location, based on computerized control of an appropriate set of servo motors to rotate to open or closed positions depending on the current state of the system and its next-state requirements. Various combinations of the disclosed systems and methods may be implemented.

### CROSS-REFERENCE TO RELATED APPLICATION

This application claims the benefit of Provisional Application Ser. No. 63/669,205, filed 9 Jul. 2024, the contents of which are herein incorporated by reference in their entirety for all purposes. Also, the computer program listing appendix that is included in this patent application is hereby incorporated by reference in its entirety for all purposes.

### FIELD OF THE DISCLOSURE

This disclosure relates generally to computer-implemented electromechanical display systems and methods. More particularly, without limitation, certain embodiments relate to systems and methods for providing computerized electromechanical gravity-assisted clocks in which the display elements comprise physical movable objects such as disks, tokens, coins, chips, checkers, marbles, balls, or the like.

### GENERAL BACKGROUND

Various techniques and systems are known in the art for implementing displays that combine functionality with artistic or entertaining features.

For example, in classic cuckoo clocks, a timekeeping mechanism is integrated with a small automaton that pops out on the hour, often accompanied by a bird call. Such features add layers of whimsy and surprise to the basic function of telling time. Large-scale installations such as the Glockenspiel clock tower at Disneyland's “It's a Small World” ride take the concept to a grander level of themed spectacles. In that example, the time display becomes part of a moving, miniature world with animated characters and scenes. This transforms checking the time into an immersive experience. More recently, kinetic artists have advanced the state of the art further, by creating clocks that are essentially sculptures in motion. Marble clocks, for example, use marbles of different colors and/or sizes rolling down multiple ramps to create digital clock displays that can be updated every minute, or even more frequently. The movement of the marbles through the clock system is controlled by computers, along with related sensors and actuators (such as motors and conveyor belts). The mesmerizing movement of the marbles through the system adds an artistic dimension to the functionality of the clock.

There exists a need for additional innovation, panache, and showmanship in the art. It is therefore desirable to address the limitations in the known art by means of the systems and methods described herein.

### BRIEF DESCRIPTION OF THE DRAWINGS

Reference is made to the accompanying exemplary drawings, which are not to scale.

FIG. 1 is an exemplary block diagram of a computing system that may be used to implement aspects of certain embodiments of the present invention.

FIG. 2 depicts an exemplary networked environment in which systems and methods, consistent with exemplary embodiments of the present invention, may be implemented.

FIGS. 3A-3D depict four views of an exemplary disk-shaped physical display element that may be used to implement aspects of certain embodiments of the present invention.

FIG. 4 is an exemplary block diagram of a computer-controlled electromechanical display system based on physical display elements that may be used to implement aspects of certain embodiments of the present invention.

FIG. 5 is another exemplary diagram of a computer-controlled electromechanical display system based on physical display elements that may be used to implement aspects of certain embodiments of the present invention.

FIG. 6 depicts an exemplary set of digit shape definitions in a 3×6 format consistent with exemplary embodiments of the present invention.

FIG. 7 is an exemplary version of FIG. 5, in which the display elements have been positioned in a display area to display the digits “1045,” which may represent a time, such as 10:45(i.e., 10 hours, 45 minutes).

FIG. 8 is an exemplary flow chart of a computer-controlled electromechanical display system controller method based on physical display elements that may be used to implement aspects of certain embodiments of the present invention.

FIG. 9 is an exemplary flow chart, depicting exemplary sub-steps to implement display buffer population steps in a computer-controlled electromechanical display system controller method based on physical display elements that may be used to implement aspects of certain embodiments of the present invention.

### DETAILED DESCRIPTION

Those of ordinary skill in the art will realize that the following description of the present invention is illustrative only and not in any way limiting. Other embodiments of the invention will readily suggest themselves to such skilled persons upon their having the benefit of this disclosure. Reference will now be made in detail to specific implementations of the present invention, as illustrated in the accompanying drawings. The same reference numbers will be used throughout the drawings and the following description to refer to the same or like parts.

Certain figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions that execute on the computer or other programmable apparatus create structures for implementing the functions specified in the flow chart block or blocks. These computer program instructions may also be stored in computer-readable memory that can direct a computer or other programmable apparatus to function in a particular manner, such that the instructions stored in computer-readable memory produce an article of manufacture including instruction structures that implement the function specified in the flow chart block or blocks. The computer program instructions may also be loaded onto a computer or other programmable apparatus to cause a series of operational steps to be performed on the computer or other programmable apparatus to produce a computer-implemented process such that the instructions that execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems that perform the specified functions or steps, or combinations of special purpose hardware and computer instructions.

For example, any number of computer programming languages, such as C, C++, C # (CSharp), Perl, Ada, Python, Pascal, SmallTalk, FORTRAN, assembly language, and the like, may be used to implement aspects of the present invention. Further, various programming approaches such as procedural, object-oriented or artificial intelligence techniques may be employed, depending on the requirements of each particular implementation. Compiler programs and/or virtual machine programs executed by computer systems generally translate higher-level programming languages to generate sets of machine instructions that may be executed by one or more processors to perform a programmed function or set of functions.

In the descriptions in this document, certain embodiments are described in terms of particular data structures, preferred and optional enforcements, preferred control flows, and examples. Other and further applications of the described methods, as would be understood after review of this application by those with ordinary skill in the art, are within the scope of the claimed invention.

The term “machine-readable medium” should be understood to include any structure that participates in providing data that may be read by an element of a computer system. Such a medium may take many forms, including but not limited to, non-volatile media, volatile media, and transmission media. Non-volatile media include, for example, optical or magnetic disks and other persistent memory such as devices based on flash memory (such as solid-state drives, or SSDs). Volatile media include dynamic random access memory (DRAM) and/or static random access memory (SRAM). Transmission media include cables, wires, and fibers, including the wires that comprise a system bus coupled to a processor. Common forms of machine-readable media include, for example and without limitation, a floppy disk, a flexible disk, a hard disk, a solid-state drive, a magnetic tape, any other magnetic medium, a CD-ROM, a DVD, or any other optical medium.

As used herein, the term “computer system” is defined to include one or more processing devices (such as a central processing unit (“CPU”) or graphics processing unit (“GPU”)) for processing data and instructions that are coupled with one or more data storage devices for exchanging data and instructions with the processing unit, including, but not limited to, RAM, ROM, internal SRAM, on-chip RAM, on-chip flash, CD-ROM, hard disks, and the like. Examples of computer systems include everything from a controller to a laptop or desktop computer, to a super-computer. The data storage devices can be dedicated, i.e., coupled directly with the processing unit, or remote, i.e., coupled with the processing unit over a computer network. It should be appreciated that remote data storage devices coupled to a processing unit over a computer network can be capable of sending program instructions to the processing unit for execution. In addition, the processing device can be coupled with one or more additional processing devices, either through the same physical structure (e.g., a parallel processor), or over a computer network (e.g., a distributed processor.). The use of such remotely coupled data storage devices and processors will be familiar to those of skill in the computer science arts. The term “computer network” as used herein is defined to include a set of communications channels interconnecting a set of computer systems that can communicate with each other. The communications channels can include transmission media such as, but not limited to, twisted pair wires, coaxial cable, optical fibers, satellite links, or digital microwave radio. The computer systems can be distributed over large, or “wide,” areas (e.g., over tens, hundreds, or thousands of miles, WAN), or local area networks (e.g., over several feet to hundreds of feet, LAN). Furthermore, various local-area and wide-area networks can be combined to form aggregate networks of computer systems.

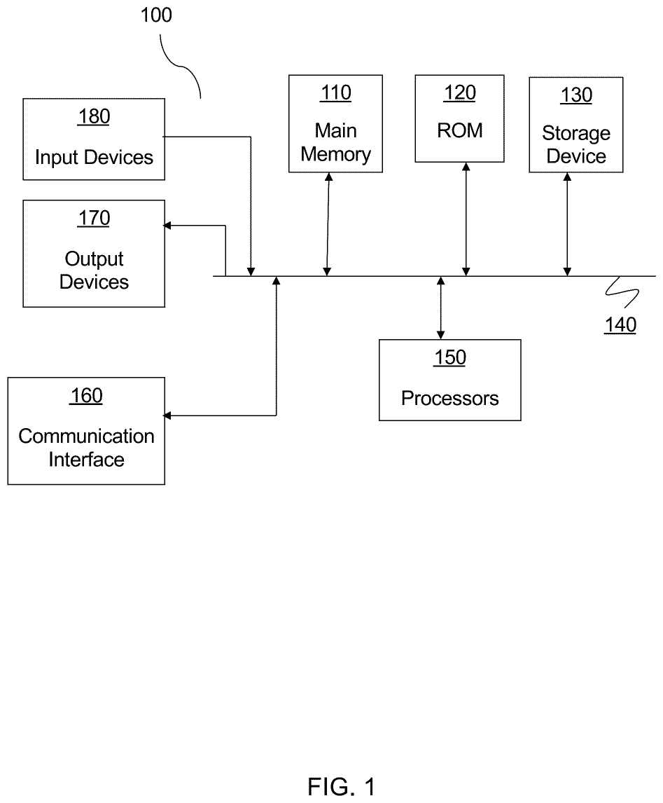

FIG. 1 is an exemplary block diagram of a computing system 100 that may be used to implement aspects of certain embodiments of the present invention. Computing device 100 may include, without limitation, a bus 140, one or more processors 150, main memory 110, a read-only memory (ROM) 120, a storage device 130, one or more input devices 180, one or more output devices 170, and a communication interface 160. Bus 140 may include, without limitation, one or more conductors that permit communication among the components of computing device 100.

Processors 150 may include, without limitation, any type of conventional processors, microprocessors, CPUs, GPUs, or processing logic that interprets and executes instructions. Main memory 110 may include, without limitation, a random-access memory (RAM) or another type of dynamic storage device that stores information and instructions for execution by processors 150. ROM 120 may include, without limitation, a conventional ROM device or another type of static storage device that stores static information and instructions for use by processors 150. Storage device 130 may include, without limitation, a magnetic and/or optical recording medium and its corresponding drive.

Input device(s) 180 may include, without limitation, one or more conventional mechanisms that permit a user to input information to computing device 100, such as a keyboard, a mouse, a pen, a stylus, handwriting recognition, voice recognition, biometric mechanisms, touch screen, and the like. Output device(s) 170 may include, without limitation, one or more conventional mechanisms that output information to the user, including a display, a printer, a speaker, and the like. Communication interface 160 may include, without limitation, any transceiver-like mechanism that enables computing device 100 to communicate with other devices and/or systems. For example, communication interface 160 may include, without limitation, mechanisms for communicating with another device or system via a network.

As described in detail herein, computing device 100 may perform operations based on software instructions that may be read into memory 110 from another computer-readable medium, such as data storage device 130, or from another device via communication interface 160. The software instructions contained in memory 110 cause one or more processors 150 to perform processes that are described elsewhere. Alternatively, hardwired circuitry may be used in place of, or in combination with, software instructions to implement processes consistent with the present invention. Thus, various implementations are not limited to any specific combination of hardware circuitry and software.

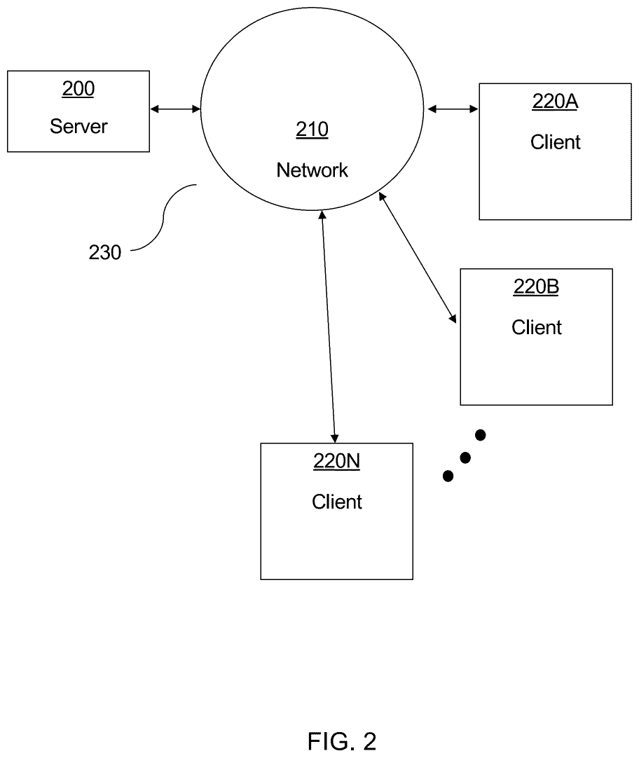

FIG. 2 depicts an exemplary networked environment 230 in which systems and methods, consistent with exemplary embodiments of the present invention, may be implemented. As illustrated, networked environment 230 may include, without limitation, a server (200), one or more clients (220A-220N), and a network (210). The exemplary simplified number of servers (200), clients (220A-220N), and networks (210) illustrated in FIG. 2 can be modified as appropriate in a particular implementation. In practice, there may be additional servers (200), clients (220), and/or networks (210).

In certain embodiments, a client 220 may connect to network 210 via wired and/or wireless connections, and thereby communicate or become coupled with server 200, either directly or indirectly. Alternatively, client 220 may be associated with server 200 through any suitable tangible computer-readable media or data storage device (such as a disk drive, CD-ROM, DVD, or the like), data stream, file, or communication channel.

Network 210 may include, without limitation, one or more networks of any type, including a Public Land Mobile Network (PLMN), a telephone network (e.g., a Public Switched Telephone Network (PSTN) and/or a wireless network), a local area network (LAN), a metropolitan area network (MAN), a wide area network (WAN), an Internet Protocol Multimedia Subsystem (IMS) network, a private network, the Internet, an intranet, a cellular network, and/or another type of suitable network, depending on the requirements of each particular implementation.

One or more components of networked environment 230 may perform one or more of the tasks described as being performed by one or more other components of networked environment 430.

Details regarding the foregoing components (e.g., as depicted in FIGS. 1 and 2), which may be implemented in a single computing device or distributed among multiple computing devices, are described throughout this document.

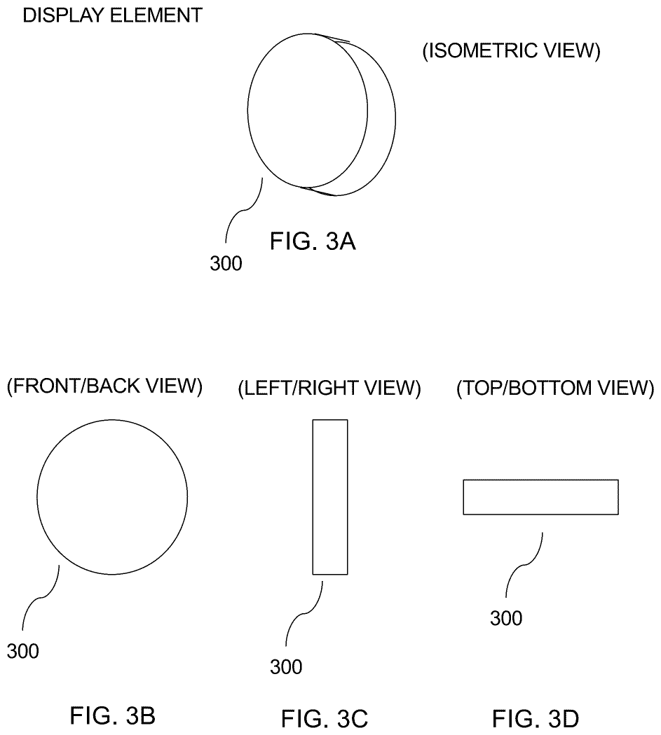

FIGS. 3A-3D depict four views of an exemplary disk-shaped physical display element that may be used to implement aspects of certain embodiments of the present invention. In certain embodiments, display element 300 comprises a 3D-printed plastic disk (which alternatively may be called, without limitation, a token, chip, coin, checker, cylinder, or a similar name) comprising polylactic acid (PLA) and having a diameter of approximately 30 mm, a thickness of approximately 7 mm, and a mass of approximately 1.7 grams. Each display element exhibits a display attribute (such as a color), and each display according to aspects of the present invention may comprise multiple display elements, wherein a first set of display elements exhibits a first display attribute, a second set of display elements exhibits a second display attribute, and other sets of display elements exhibit additional display attributes. For example, in one embodiment, some display elements are red plastic disks and some display elements are yellow plastic disks. In other embodiments, display elements may comprise spheres (which alternatively may be called, without limitation, marbles, balls, or similar names), rings, or any suitable shape known to skilled artisans, depending on the requirement of each particular implementation. Display elements of different shapes or sizes may also be incorporated into certain embodiments.

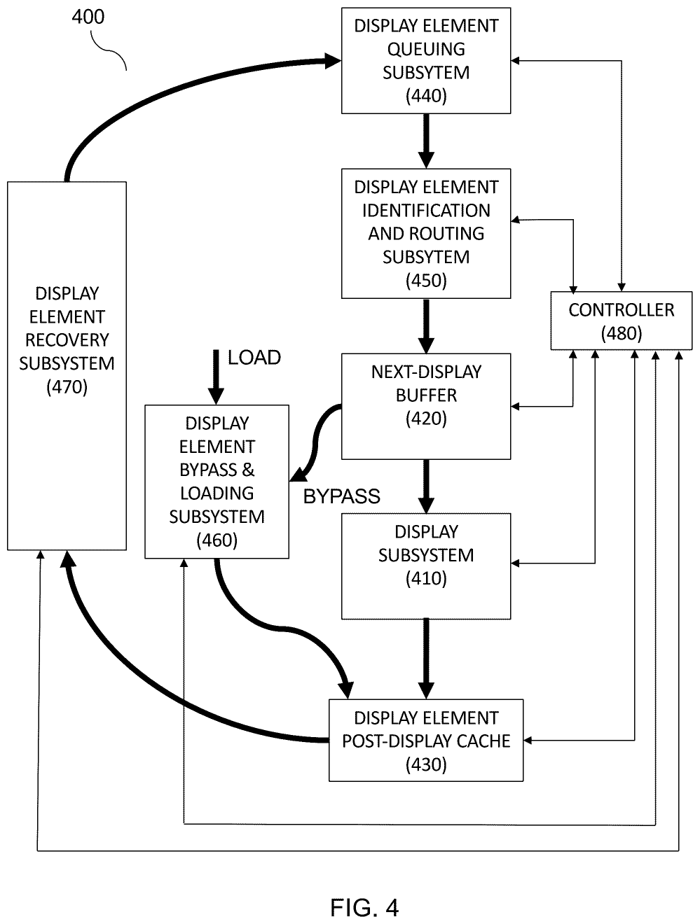

FIG. 4 is an exemplary block diagram of a computer-controlled electromechanical display system based on physical display elements (such as display element 300 depicted in FIGS. 3A-3D) that may be used to implement aspects of certain embodiments of the present invention.

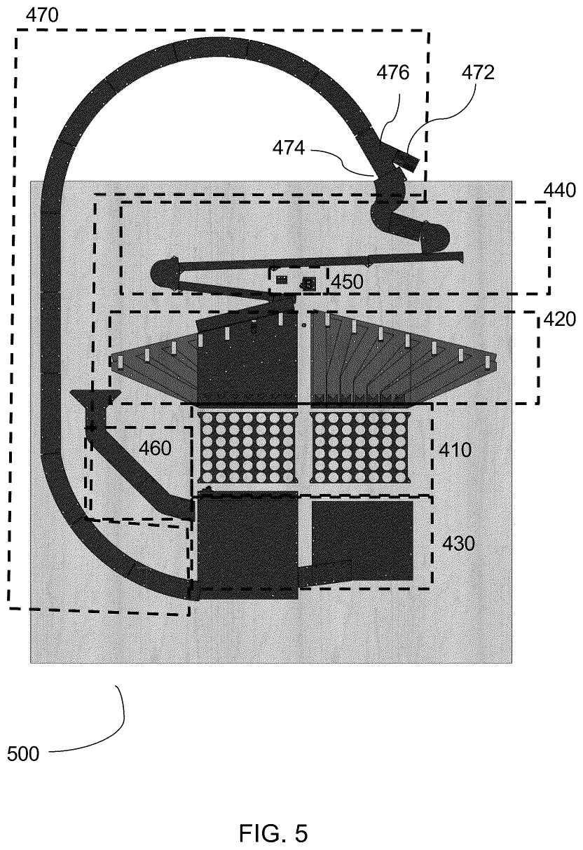

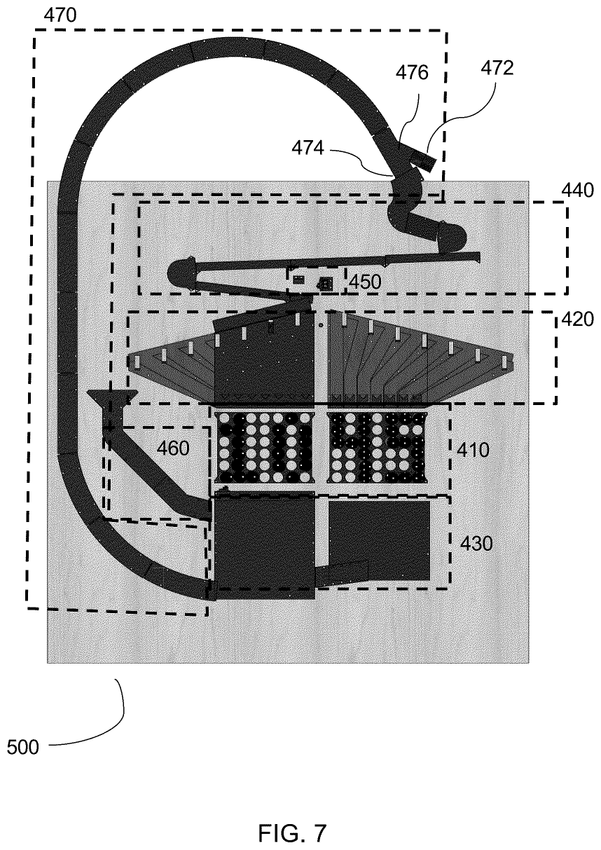

Referring to FIG. 4, the system in one embodiment comprises display subsystem 410, next-display buffer 420, display element post-display cache 430, display element bypass and loading system 460, display element recovery subsystem 470, display element queuing system 440, display element identification and routing system 450, and controller 480. In certain embodiments, the system is arranged essentially vertically, so that gravity may advantageously be used as a force that partially controls the movement of display elements through the system. Thus, the components depicted in FIG. 4 may roughly also be viewed as being arranged in the physical orientation of an actual physical embodiments, with components that appear higher in the figure generally corresponding to components that are located higher (relative to the center of the earth) in the physical system. This is also depicted in FIGS. 5 and 7, which depict the physical and mechanical components arranged vertically on a substrate (such as a sufficiently large piece of plywood or other suitable material, in one case measuring four feet wide and six feet tall), with the numerals of the corresponding components overlaid on the physical components. The dashed lines in FIGS. 5 and 7 roughly correspond to the boundaries of each of the components of the system depicted in FIG. 4.

As shown in FIGS. 5 and 7, display subsystem 410 in one embodiment consists of two display areas, each comprising seven columns and six rows of predetermined locations for display elements. Individual servo motors (not shown) are located at the top and bottom of each column, with each servo motor being independently controlled by controller 480. At the appropriate time, as determined by software running on controller 480, each of the 14 servo motors at the top of each column, and each of the 14 servo motors at the bottom of each column, are independently commanded to rotate to an open or closed position, so as to drop one or more display elements into a lower area of the system (i.e., to a specified display element position within next-display buffer 420 or display subsystem 410), as described in further detail herein. The details for how and when to command each of the servo motors in the system to rotate to an open or closed position according to a particular embodiment are set forth in the accompanying Python code that is attached to this document.

As generally described above, FIG. 5 is an exemplary diagram of a computer-controlled electromechanical display system based on physical display elements that may be used to implement aspects of certain embodiments of the present invention.

Referring to FIGS. 4 and 5, from the perspective of an observer of the system, in certain embodiments, its operation may be described as follows:

Display element queuing subsystem 440 may be implemented as a set of connected ramps on which a plurality of display elements 300 roll in a gradually descending path toward display element identification and routing subsystem 450. The set of ramps may completely enclose the rolling display elements 300, or some or all of the ramps may include a guard rail such that the display elements roll down the ramp without falling off the system. Because the display elements 300 in certain environments comprise discs, when they are oriented such that their circular sides are facing toward the front and the rear of the system, they essentially behave like wheels gradually descending down the ramp system of display element queuing subsystem 440. The ramp system may be as simple or as complex as may be desired, depending on the needs of each particular implementation. For maximum visual effect, or to achieve a desired artistic or entertainment benefit, certain embodiments of the ramp system of display element queuing subsystem 4040 may be relatively elaborate and comprise complicated ramp structures, extending in multiple directions, so long as there is a gradual descent of display elements 300 due the effects of gravity toward the display element identification and routing subsystem 450. Display elements 300 may be loaded onto display element queuing subsystem 440 by any technique known to skilled artisans, such as manual loading, loading from display element recovery subsystem 470, or loading through display element bypass and loading subsystem 460, then through display element post-display cache 430, and finally through display element recovery system 470. Exemplary embodiments for implementing such loading steps are described in this document.

In certain embodiments, some or all of the ramp system of display element queuing subsystem 440 may be replaced with other visually interesting mechanisms for affecting the movement of display elements 300, such as “plinko”-style peg boards that cause display elements to bounce off pegs in unpredictable directions, traps or holes through which display elements 300 may fall so as to continue on another part of subsystem 440, elevators or conveyor belts for display elements 300, and the like.

In certain embodiments, display element queuing subsystem 440 causes a plurality of display elements 300 to be positioned and stopped in a queue of rolling display elements that are ready to be presented to display element identification and routing subsystem 450.

Display element, identification and routing subsystem 450, in certain embodiments, comprises a color sensor (e.g., a commercially available TCS34725 device, having I2C interface), followed by a servo motor (e.g., a commercially available SG90 device) that can be commanded to rotate to an open or closed position so as to act as a gate, selectively, allowing the next display element 300 in the queue to continue to the next, lower, part of the system, which in the case of certain embodiments comprises next display buffer 420.

In certain embodiments, the color sensor and the servo motors in the system are coupled via an I2C interface to controller 480 (e.g., commercially available Raspberry Pi 4 Model B, connected in parallel to three independently addressable commercially available PCA9685 16-channel 12-Bit PWM servo motor driver modules), which executes system code in accordance with the source code appendix included herein. Controller 480, in certain embodiments, receives sensor data from, and/or transmits control commands to, various other subsystems in the system, depending on the requirements of each particular implementation, as shown in FIG. 4. Controller 480 may be implemented as a single device or as multiple devices (with or without communication among such multiple devices), depending on the requirements of each particular implementation.

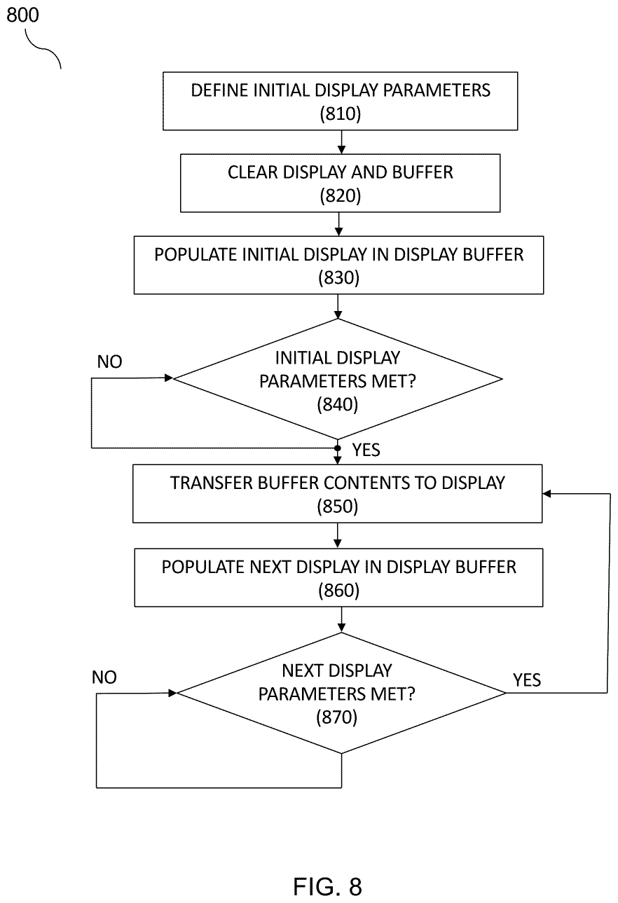

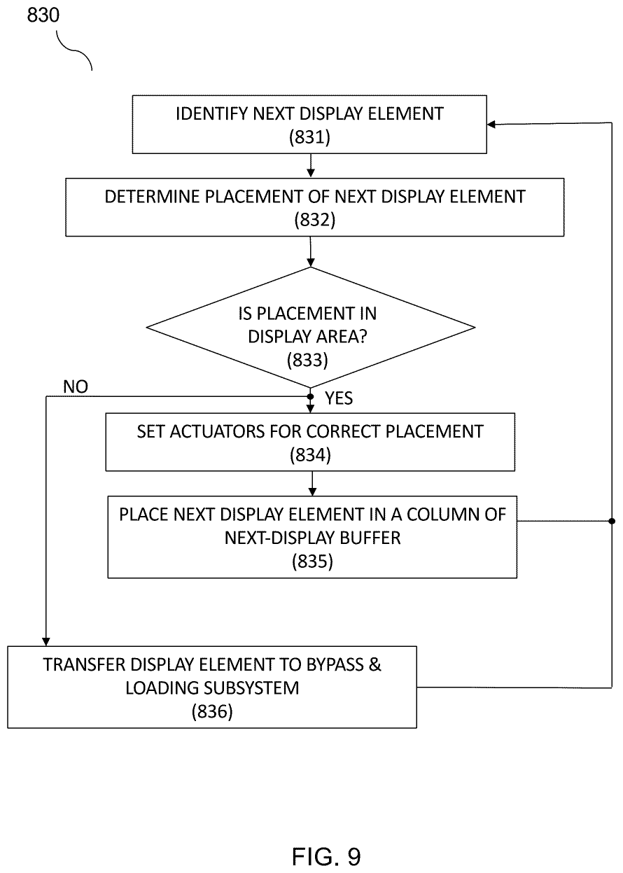

As will be described in more detail later in this document with reference to FIGS. 8 and 9, the system code determines whether the next display element 300 may beneficially be placed within next display buffer 420 or display subsystem 410. If so, controller, 480 commands, the appropriate set of servo motors in the system to rotate to the correct positions, that is open or closed, so as to cause next display element 300 to roll into the commanded display element location. For example, if controller 480 determines that the next display element to be placed in the rightmost column of display subsystem 410 is a red display element 300, and the next display element 300 currently detected by the color sensor in display element identification and routing system 450 is red, then controller 480 commands an appropriate set of servo motors to open and/or close so as to cause that next display element 300 to be dropped into the rightmost column of display subsystem 410, either on top of any other previously placed display elements 300 in that column, or as the lowest and first display element in that particular column.

Otherwise, if controller 480 determines that the next display element 300 currently at the front of the queue and therefore being observed by the color sensor cannot be been officially located within any area of next-display buffer 420 or display subsystem 410, then controller 480 causes an appropriate set of servo motors to be commanded to rotate to open or closed positions that will cause the next display element 300 to roll into display element bypass and loading subsystem 460, for eventual routing into display element post display cache 430 and then through display element recovery subsystem 470 for eventual placement at the top of display element queuing subsystem 440, so that that display element 300 will be available for placement once again when that display element 300 reaches the front of the display element queue, and therefore the color sensor once more.

As shown in FIG. 5, in certain embodiments next-display buffer 420 comprises a left half and a right half, with a downwardly sloping ramp at the top of each half and a set of servo motors with attached flappers that partially define the top edge of each of those ramps, on which display elements may roll when a servo motor is commanded to rotate to a closed position. In certain embodiments, the process of setting the appropriate set of servo motor positions in the system so as to effect correct placement of each display element 300 comprises rotating a left/right servo motor ramp in the middle of next display buffer 420 so as to selectively route a display element 300 to the indicated ramp (i.e., left or right) at the top of buffer 420, as well as commanding one of the servo motors at the top of the ramps in next display buffer 420 to open. This causes the display element 300 that has been commanded to advance past the gate in display element identification and routing subsystem 450 to drop either into one of the 14 columns of next display buffer 420, or into display element bypass and loading subsystem 460. The details are set forth in the exemplary Python controller code that is included in this document.

Certain embodiments comprise 44 servo motors: 14 servo motors at the top (ramp) area of each of the 14 columns of next-display buffer 420 (to selectively cause one or more display elements 300 to drop into the next-display buffer column corresponding to each of those motors), 14 servo motors at the bottom of each of the 14 columns of next-display buffer 420 (to selectively cause one or more display elements 300 in one column of next display buffer 420 to drop into a corresponding column of display subsystem 420), 14 servo motors at the bottom of each of the 14 columns of display subsystem 410 (to selectively cause one or more display elements 300 in one column of display subsystem 410 to drop into a display element post-display cache 430), one gate servo motor following the color sensor in display element identification and routing subsystem 450, and one routing ramp motor near the top (vertically) of the middle (horizontally) of next-display buffer 420, to selectively route one or more display elements 300 to the left or right half of next-display buffer 420.

Display element bypass and loading subsystem 460, in certain embodiments, comprises a first display element loading port facilitate manual loading of display elements 300 into the system or to enable coupling to an automatic display element loading system (not shown), a second port coupled to next-display buffer 420 to accept display elements 300 not selected for transmission to next-display buffer 420 or to display sub-system 410, and an output port to enable display elements 300 to drop into display element post-display cache 430 and eventual routing through display element recovery subsystem 470. In certain embodiments, as display elements 300 move through the system, the enclosures surrounding the display elements 300 ensure that display elements 300 are always oriented such that one of their circular sides is always facing toward the front or back of the system, so as to enable the disk-shaped display elements 300 to roll through the various portions of the system.

In certain embodiments, display element post-display cache 430 functions as a temporary storage and routing area for display elements 300. Display elements 300 are routed to display-element post-display cache 430 either from display subsystem 410 (when one or more columns of display elements are dumped or cleared from display subsystem 410 under controller control), or from display element bypass & loading subsystem 460 (under gravity control). Other embodiments may route display elements 300 into display element post-display cache 430 directly or indirectly from other subsystems, such as, without limitation, next-display buffer 420, depending on the requirements of each particular implementation.

Because certain embodiments advantageously use gravity as a force to cause display elements 300 to roll or drop from one subsystem to another in the system, and/or within a subsystem, at a certain point during operation of a system according to aspects of the present invention, display elements reach their minimum potential energy state in the system (e.g., their lowest vertical location) and must be recirculated via subsystems that require energy input to a higher-potential-energy portion of the system (such as the top of display element queuing subsystem 440) for use in another cycle of the system in operation. In certain embodiments, display element recovery subsystem 470 performs this recirculation task. In simple embodiments, recirculation may be performed manually (e.g., by causing humans or other animals to lift display elements from display element post-display cache 430 and insert them into display element queuing subsystem 440). However, in certain embodiments, there is an emphasis on the artistic, aesthetic, and/or entertainment attributes of the system as display elements 300 travel through the system. Therefore, certain embodiments implement display element recovery subsystem 470 with such attributes as design goals.

For example, certain embodiments utilize conveyor belts, pinball-style solenoids, magnetic actuators, or other movement-causing mechanisms to lift display elements 300 from display element post-display cache 430 to display element queuing subsystem 440. Other embodiments advantageously use vacuum forces to cause the upward movement of display elements 300, by coupling a commercially available vacuum cleaner hose, or other suitable source of vacuum energy, to vacuum port 472 near the top of display element queuing subsystem 440 (see FIGS. 5 and 7). A movable flap 474 (not visible in FIGS. 5 and 7, but at the position indicated in those figures) closes when the vacuum cleaner (not shown) is activated, creating a vacuum force that causes one or more display elements 300 in display post-display cache 430 to accelerate rapidly from display element post-display cache 430 toward display element queuing subsystem 440 through an enclosed rectangular track sized to accommodate the moving display elements while maintaining their orientation such that one of their circular sides faces the front or rear of the system. A perforated screen 476 (not visible in FIGS. 5 and 7, but at the position indicated in those figures) near flap 474 between the vacuum cleaner coupling port and the rectangular display element routing track ensures that display elements 300 are not sucked into the vacuum cleaner but instead proceed to display element queuing subsystem 440 through flap 474. In certain embodiments, moveable flap 474 opens to facilitate passage of display elements into display element queuing subsystem 440 due either to the momentum of display elements 300 as they impact flap 474, or to selective deactivation of the vacuum cleaner as display elements 300 approach or become queued near flap 474. The vacuum cleaner may be selectively activated or deactivated under manual or automatic control, which may be synchronous or asynchronous to movement of display elements in other portions of the system. In certain embodiments, the vacuum cleaner is automatically activated for a few seconds (e.g., four seconds) every minute, asynchronously. Such control may be effected by programming a commercially available [model] DMX controller.

To enhance the artistic, aesthetic, and/or entertainment features of certain embodiments, display element recovery subsystem 470 may be implemented as a long and complex three-dimensional enclosed track that causes display elements 300 to move rapidly due to the vacuum forces through a series of twists, loops, curves, and/or straightaway ramps as they travel from display element post-display cache 430 to display element queuing subsystem 440. Thus, in certain embodiments, the physical path from display element post-display cache 430 to display element queuing subsystem 440 may be significantly longer and more complex as compared to the simplest path that may be implemented for purely functional reasons.

Certain embodiments implement sorting of display elements 300 (e.g., color-based sorting) at various points in the system, so as to provide queues of segregated display elements 300 (such as one queue of red display elements and a separate queue of yellow display elements). Such implementations enable faster operation of various portions of the system in circumstances where rapid access to specific types of display elements (e.g., a sequence of two red display elements followed by three yellow display elements, followed by one red display element) is required. Other embodiments segregate display elements at the end of display element identification and routing subsystem 450, as display elements selectively proceed after color sensing either into a column of next-display buffer 420 or into display element bypass & loading subsystem 460.

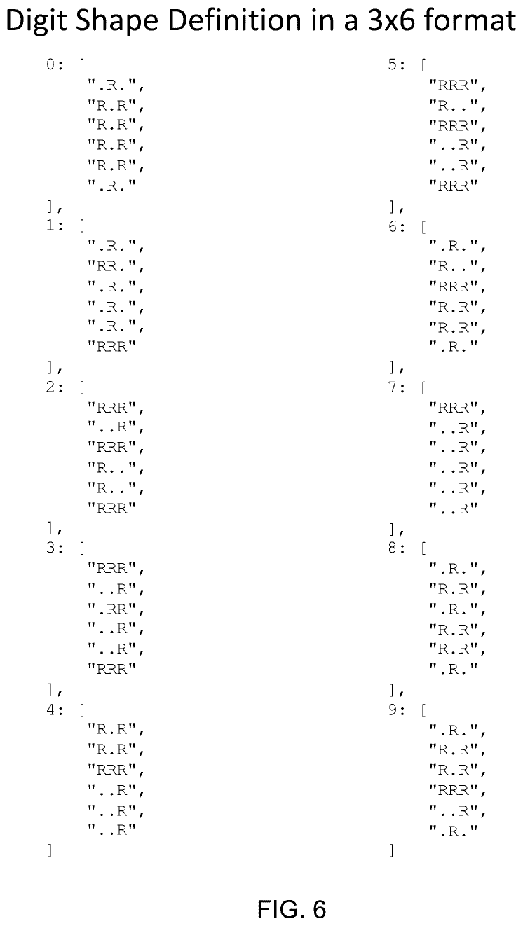

FIG. 6 depicts an exemplary set of digit shape definitions in a 3×6 format consistent with exemplary embodiments of the present invention. In certain embodiments, system 400 comprises a working clock, with the current time in hours and minutes shown and updated every minute (if possible within the constraints of the system) on display subsystem 410. The shape definitions depicted in FIG. 6 may be used to display each of the ten digits (from zero to nine) necessary for the clock display. “R” in the examples of FIG. 6 indicates a red display element 300, for example, whereas a dot (“.”) indicates a display element of a different color, such as yellow.

FIG. 7 is a version of FIG. 5, i.e., an exemplary diagram of a computer-controlled electromechanical display system based on physical display elements that may be used to implement aspects of certain embodiments of the present invention, in which the display elements have been positioned in a display area to display the digits “1045,” which may represent a time, such as 10:45 (i.e., 10 hours, 45 minutes).

FIG. 8 is an exemplary flow chart of a computer-controlled electromechanical display system controller method based on physical display elements that may be used to implement aspects of certain embodiments of the present invention.

At step 810, a set of initial display parameters are defined. For example, in a system where the initial display set-up time is four minutes and the current time is determined to be 10:40 pm, a portion of the initial display parameters may be set to 10:45 pm, with an extra minute to allow for any unexpected additional delay in the initial display set-up time.

Next, at step 820, the display subsystem 410 and next-display buffer 420 are cleared by commanding all relevant servo motors to open, so as to cause the corresponding display elements that may be above any such now-open servo motors to drop down into the next area of the system. At the end of step 820, in certain embodiments all display elements that were previously located above display element post display cache 430 and below display element identification and routing subsystem 450 are caused to drop into display element post display cache 430. This sets the system in a clean and clear initialization state.

Next, at step 830, an initial display is populated, either in the next display buffer 420 or directly into display subsystem 410. Details for performing this step in certain embodiments are set forth in FIG. 9, as well as in the source code appendix that is part of this document. For example if the initial display parameters were sent to 10:45 pm, as the next display element 300 at the bottom of display element identification and routing subsystem 450 is presented to the color sensor and identified as being of a particular color, it is either routed into the right-most column of next-display buffer 420 that requires that color of display element at the top of its current stack, or otherwise into display element bypass and loading subsystem 460 (if no suitable column is determined), proceeding as quickly as possible to processing of the next display element 300 now located at the color sensor. The process continues until display buffer 420 is loaded with display elements 300 that will cause display system 410 to display the digits “1” “0” “4” “5” (reading from left to right) when those display elements currently in next-display buffer 420 are transferred to display subsystem 410.

Upon the completion of step 830, that is, when the initial display is populated by transferring the appropriate set of display elements 300 into next-display buffer 420 that corresponds to the initial display parameters in the correct order and display element locations, in certain embodiments the system checks at step 840 whether the current time has reached the time that corresponds to the appropriate set of initial display parameters, in this case 10:45 pm. If not, the system waits by looping back to step 840 until the current time equals 10:45 pm. Otherwise, if the initial display parameters are satisfied, that is, when the current time reaches 10:45 pm, then the system proceeds to step 850.

Step 850, the contents of next display buffer 420 are transferred to display subsystem 410 by opening the set of servo motors corresponding to the columns of next display buffer 420 that contain new sets of display elements to be displayed on display subsystem 410. In the case of an initial display, all 14 columns of display elements 300 in next-display buffer 420 are necessarily caused to drop into the corresponding columns of display subsystem 410. According to the example that has been described above, execution of step 850 causes display subsystem 410 to display the digits “1” “0” “4” “5”, reading from left to right, as shown in FIG. 7.

At the completion of step 850, the next display is populated in next-display buffer 820, during the performance of step 860. During this step, the next time to be presented on display subsystem 410 (e.g., 10:46 pm) is populated in next-display buffer 420, with a goal of completing step 860 within one minute, so that display subsystem 410 may be updated at the appropriate time (i.e., in the above example, so that the columns of display elements 300 that change from 10:45 to 10:46 are flushed from display subsystem 410 and replaced with the ready corresponding columns of display elements 300 in next-display buffer 420 when the current time reaches 10:46 pm). With reference to FIG. 6 and the above example, the only columns that change (and therefore that need to be updated) from a display that shows “1045” to one that shows “1046” are the right-most column and the column two columns to the left of that column, with both of those columns appearing in the right-most digit of the minute counter in the clock display. Thus, because the code executing in controller 480 is programmed in certain embodiments to update only the columns that change from one display to the next, efficiencies and time advantages are gained that facilitate correctly updating the clock display every minute. Even during more complex display changes that may involve updating most (or even all) columns of display elements 300 (such as changing from “1159” to “0000”), careful design of all system parameters in accordance with techniques known to skilled artisans assists with providing correct display updates at the required time intervals, depending on the particular requirements of each implementation.

Referring to FIG. 8, after execution of step 860 (i.e., after the columns of display elements 300 that are required to be loaded into the correct locations in next-display buffer 420 before the next update time, for example, by performing the actions necessary to control next-display buffer 420 to be ready to update the display from “1045” to “1046” in the above example), controller 480 checks whether the next display parameters have been satisfied (e.g., whether the current time has reached 10:46 pm. If not, the system waits by looping back to step 870. If so, the process loops back to step 850 to update display 410 by dropping the changing columns of display elements 300 from display subsystem 410 and replacing them with the appropriate columns of display elements 300 that are ready in next-display buffer 420.

Thus, the system according to aspects of the present invention in certain embodiments provides a novel, visually appealing, and interesting process for updating a clock display, with portions of display subsystem 410 being updated every minute, and with display elements 300 periodically accelerating rapidly from display element post-display cache 430 through display element recovery subsystem 470 and into display element queuing subsystem 440 in a visually compelling manner that provides an entertaining and impressive user experience.

FIG. 9 is an exemplary flow chart, depicting exemplary sub-steps to implement display buffer population steps (such as steps 830 and 860 as shown in FIG. 8) in a computer-controlled electromechanical display system controller method based on physical display elements that may be used to implement aspects of certain embodiments of the present invention. Additional details are provided in the accompanying Python source code listing for the program that is executed by controller 480 in certain embodiments.

At step 831, the next display element 300 is identified in certain embodiments, for example by detecting the color of the display element 300 that is currently at the front of display element identification and routing subsystem 450 and therefore currently presented to the color sensor. In certain embodiments, identification step 831 results in three possible values: red, yellow, or empty. If the result of step 831 in certain embodiments is “empty,” then the method of FIG. 9 loops back to step 831 until a display element 300 is detected at the color sensor position (i.e., until the result of step 831 is not “empty”).

Next, at step 832, placement of the detected display element 300 is determined. In certain embodiments, as described earlier, a detected display element 300 may be routed to one of the 14 columns in next-display buffer 420, or to display element bypass and loading subsystem 460. If at step 832, placement of the next display element 300 is determined to be within display area of display subsystem 410 (see step 833 in FIG. 8), routing is effected in certain embodiments by commanding an appropriate set of servo motors as determined by the program executing on controller 480 to rotate to the appropriate open or closed positions as display element 300 rolls down the various ramps in the system (see step 834 in FIG. 8). In addition to providing the correct placement routing, this process in certain embodiments provides additional visual, aesthetic, and entertainment effects as a series of display elements 300 roll down different paths, and as different gates in the system open and close in rapid succession as the servo motors rotate to control the movement of display elements 300. Execution of step 835 in certain embodiments results in the placement of a display element 300 into one of the 14 columns of next-display buffer 420, or directly into a corresponding column of display subsystem 410 if the appropriate servo motors at the bottom of the corresponding column of next-display buffer 420 is commanded to rotate to an open position during the appropriate time period, as determined in accordance to the requirements of each particular implementation. Step 835 concludes in certain embodiments by looping back to step 831 and thereby identifying the next display element 300 in the queue.

In certain embodiments, an algorithm executed by controller 480 during the process depicted in FIG. 9 prioritizes those columns of next-display buffer 420 that are closest to the right edge of next-display buffer 420. This is because, in the clock display of certain embodiments, the columns closer to the right side of next-display buffer 420 are likely to change more often because they represent the minutes portion of the time value being displayed. Thus, in certain embodiments, the algorithm executing on controller 480 first determines whether the right-most of the 14 columns of next-display buffer 420 requires the current display element 300 that is at the front of display element identification and routing subsystem 450. If so, that display element 300 is routed to the right-most column, and therefore drops onto the top of the stack of display elements that have previously been routed to that column (or to the bottom of the stack if there are no such previously routed display elements currently in that column). Otherwise, the algorithm determines whether the next column in right-to-left order requires that next display element 300, and so on until the leftmost column of next-display buffer 420 is considered for possible acceptance of that display element 300. In certain embodiments, the case in which none of the 14 columns of next-display buffer 420 require the display element to 300 currently at the front of the queue is handled as shown in FIG. 9 by determining that the placement of the display element 300 is not within the display subsystem 410, and thereby looping through the “NO” path at the output of step 833 to step 836, during which the display element 300 is transferred to bypass and loading subsystem 460. For example, if the next display element 300 is determined to be red, and all 14 columns of next-display buffer 420 currently require a yellow display element at the next location in their stacks, that next display element 300 is routed to display element bypass & loading subsystem 460 for eventual recirculation through subsystems 430 and 470 to display element queuing subsystem 440. Details are set forth in the accompanying Python source code that is part of this document.

While the above description contains many specifics and certain exemplary embodiments have been described and shown in the accompanying drawings, it is to be understood that such embodiments are merely illustrative of, and not restrictive on, the broad invention, and that this invention is not to be limited to the specific constructions and arrangements shown and described, since various other modifications may occur to those ordinarily skilled in the art, as mentioned above. The invention includes any combination or sub-combination of the elements from the different species and/or embodiments disclosed herein.

I claim:

1. An electromechanical display system comprising:
a plurality of physical display elements, each having a display attribute;
a display subsystem comprising a plurality of display positions for receiving the display elements to form a human-readable display;
a next-display buffer configured to temporarily store display elements for a next update of the display subsystem;
a display element queuing subsystem configured to supply display elements in sequence;
a display element identification and routing subsystem comprising a sensor for detecting a display attribute of a display element and a controllable actuator configured to route said display element;
a controller configured to:
(a) determine, based on the detected display attribute, whether a display element is suitable for a target position in the next-display buffer; and
(b) command a set of actuators to route the display element either to the next-display buffer or to a bypass and loading subsystem; and
a display element recovery subsystem configured to recirculate bypassed display elements back to the display element queuing subsystem, wherein at least part of the system uses gravity as a primary force to move the display elements through one or more subsystems.

2. A method of updating a human-readable display using physical display elements in a gravity-assisted electromechanical system, the method comprising:
initializing display parameters based on a target display state;
clearing display elements from a display subsystem and a next-display buffer;
queuing a plurality of display elements at a queue for routing;
detecting a display attribute of a first display element at the front of said queue;
determining, by a controller, whether the display element is suitable for a location in the next-display buffer;
if suitable, actuating a set of servos to place said display element in a corresponding position in the next-display buffer;
if not suitable, actuating a set of servos to divert said display element to a bypass and loading subsystem;
recirculating diverted display elements back to the queuing subsystem; and
upon reaching a scheduled update time, transferring a set of display elements from the next-display buffer to the display subsystem.

3. An electromechanical display system comprising:
a display subsystem;
a display element post-display cache configured to receive display elements from the display subsystem after use;
a display element recovery subsystem comprising a vacuum conduit, a vacuum source coupled to the conduit, and a flap mechanism;
a routing channel sized to maintain display element orientation; and
a perforated barrier configured to prevent display elements from entering the vacuum source, wherein the vacuum source, when activated, generates a suction force to propel display elements from the post-display cache through the routing channel and flap mechanism into a display element queuing subsystem for reuse.

4. The system of claim 1, wherein the physical display elements comprise colored disks with at least two distinct display attributes corresponding to different colors.

5. The system of claim 1, wherein the display subsystem comprises a 3×6 grid array configured to form numerical digits.

6. The system of claim 1, wherein the display element queuing subsystem comprises a descending ramp system that allows rolling motion of the display elements.

7. The system of claim 1, wherein the controller prioritizes placement of display elements in buffer columns that correspond to digits expected to change most frequently.

8. The system of claim 1, wherein the controller updates only those columns of the display subsystem that differ from a previous display state.

9. The system of claim 1, wherein the actuators include a plurality of servo motors controlled by pulse width modulation signals.

10. The system of claim 1, wherein the system comprises 14 vertical columns in the display subsystem, and each column is independently controllable via one or more actuators.

11. The method of claim 2, further comprising defining a digit-to-display-element mapping in a 3×6 character grid.

12. The method of claim 2, wherein the target display state represents a current time value.

13. The method of claim 2, wherein the step of determining suitability comprises comparing the color of the display element to a required color for a specific buffer column.

14. The method of claim 2, wherein the display elements not immediately usable are routed to a recovery path comprising a vacuum conduit.

15. The method of claim 2, further comprising asynchronously activating the vacuum source for recovery independently of display updates.

16. The system of claim 3, wherein the vacuum source comprises a consumer-grade vacuum cleaner coupled to the conduit via a detachable hose.

17. The system of claim 3, wherein the flap mechanism opens in response to either the momentum of a propelled display element or a deactivation of the vacuum source.

18. The system of claim 3, wherein the recovery subsystem includes a transparent or translucent enclosure along the conduit path for visual tracking of display elements.

19. The system of claim 3, wherein the routing channel includes at least one loop or twist to enhance visual entertainment during recovery.

20. The system of claim 3, wherein the flap mechanism comprises a spring-loaded hinge that enables one-way passage of display elements into the queuing subsystem.
